(19) United States
(12) Patent Application Publication
(10) Pub. No.: US 2024/0012155 A1
(43) Pub. Date: Jan. 11, 2024

(54) Method for Starting a GNSS Receiver Arranged in a Vehicle

(71) Applicant: Robert Bosch GmbH, Stuttgart (DE)

(72) Inventor: Tomasz Bien, Ludwigsburg (DE)

(21) Appl. No.: 18/349,134

(22) Filed: Jul. 8, 2023

(30) Foreign Application Priority Data
Jul. 11, 2022 (DE) 10 2022 207 038.0

(51) Int. Cl. G01S 19/25

(52) U.S. Cl. CPC G01S 19/252

(57) ABSTRACT

The method for starting a GNSS receiver arranged in a vehicle is disclosed. The method includes: (a) capturing, by way of an image capturing device, a first item of image information when the vehicle is started, wherein the first item of image information describes the environment of the vehicle when the vehicle is started; (b) comparing the first item of image information captured in step (a) with a second item of image information captured by the image capturing device when the vehicle is parked and describing the environment of the vehicle when the vehicle is parked in order to determine whether the first item of image information and the second item of image information deviate from each other, and (c) starting the GNSS receiver while taking the comparison result in step (b) into account.

This application claims priority under 35 U.S.C. § 119 to application no. DE 10 2022 207 038.0, filed on Jul. 11, 2022 in Germany, the disclosure of which is incorporated herein by reference in its entirety.

The present disclosure relates to a method for starting a GNSS receiver arranged in a vehicle. The disclosure can in particular be used in GNSS-based geolocation systems used for autonomous or semi-autonomous driving.

### BACKGROUND

A global navigation satellite system (abbreviated as GNSS) is a system for position determination and navigation on the ground and in the air by receiving navigation satellite signals.

GNSS receivers are now used in numerous technological solutions, including GNSS/INS positioning for autonomous driving (e.g., in combination with maps). This technology enables the precise calculation of an absolute position, speed, time, and orientation. A GNSS receiver is therefore often used in the automotive industry. Starting a GNSS receiver can be accelerated if the previously determined geolocation data have been stored and can be used for starting the GNSS receiver. This approach is referred to as a hot start, whereby the previously stored information can be utilized to accelerate filter initialization for GNSS positioning.

The risk at hot start, particularly in the case of a safety-critical receiver with high integrity requirements, is that the stored position does not match the current position when the vehicle has been moved after the GNSS receiver has entered the sleep mode (e.g., on a ferry, a train, or an automobile transporter). This can result in incorrect initialization and a safety/integrity risk.

There is therefore a desire to create an additional validation mechanism for the stored position that can be used for the hot start of the GNSS receiver.

### SUMMARY

Provided for this purpose is a method for starting a GNSS receiver arranged in a vehicle, comprising at least the following steps:
a) capturing, by way of an image capturing device, a first item of image information when the vehicle is started, whereby the first item of image information describes the environment of the vehicle when the vehicle is started,
b) comparing the first item of image information captured in step a) with a second item of image information captured by the image capturing device upon shutdown of the vehicle and describing the environment of the vehicle upon shutdown of the vehicle to determine whether the first item of image information and the second item of image information deviate from each other, and
c) starting the GNSS receiver while taking the comparison result in step b) into account.

It is known that a vehicle having a GNSS-based geolocation system can be located using a GNSS receiver. GNSS is the abbreviation for Global Navigation Satellite System (GPS, GLONASS, Galileo, and Beidou) for position determination and navigation on the ground and in the air by receiving navigation satellite signals (GNSS signals).

A navigation signal includes a ranging code, ephemeris data, and almanac data. The ranging code is relevant to measurement of the distance between the GNSS receiver and the navigation satellite broadcasting this navigation signal. The ephemeris data are relevant to determining the current position of the navigation satellite, and they must be updated regularly. The almanac data are relevant to checking the integrity of the broadcast navigation signals, and must also be updated regularly. The almanac data remain valid longer than the ephemeris data.

In order to be able to determine the position on the ground by way of a GNSS receiver, at least four navigation satellites of the same GNSS must be present in the field of view of the GNSS receiver. A navigation satellite takes up to 30 seconds to send all of its ephemeris data, so the GNSS receiver receives the ephemeris data with a time delay. When receiving all of the almanac data, the time delay can be as long as several minutes.

Therefore, it is desirable not to re-receive the almanac and/or ephemeris data after parking a vehicle and upon restarting a GNSS receiver installed in that vehicle. One of the prerequisites in this context is that the navigation satellites previously tracked by the GNSS receiver still be in the field of view of the GNSS receiver upon restart. Whether the vehicle has been transported from one location to another while it was parked must be considered as a criterion for starting without receiving almanac and/or ephemeris data again. This criterion can be tested using the described method.

According to step a), a first image information is captured by way of an image capturing device when the vehicle is started, the first item of image information describing the environment of the vehicle when the vehicle is started.

This can mean that, once a vehicle's sensory system detects that the vehicle has started, the image capturing device immediately captures a first item of image information describing the current environment of the vehicle. It is also possible that a trigger signal triggering the startup of the vehicle can also trigger the image capturing device to simultaneously capture the first item of image information.

The image capturing device is a sensor technology for perceiving the environment and can be installed in a vehicle, in particular in an automated or autonomously driving vehicle, in order to, e.g., detect obstacles during a journey. Based on the known Visual Place Recognition (VPR) approach, the geolocation process can generally also be performed using the image capturing device. It is therefore expected that a vehicle, particularly an automated or autonomously driving vehicle, can comprise both a GNSS(/INS) geolocation system and an image capturing device. It is therefore possible to create an additional validation mechanism for launching the GNSS receiver with an image acquisition device which is already installed in a vehicle. The image capturing device is particularly preferably a high-resolution camera, and the item of image information is therefore an optical image of the environment. This makes it possible to accurately and efficiently detect a location from the captured image.

According to step b), the first item of image information acquired in step a) is compared with the second item of image information that was acquired by the image capturing device when the vehicle is parked and describes the environment of the vehicle when the vehicle is parked, in order to determine whether the first item of image information and the second item of image information differ from each other.

This can mean that once a vehicle's sensors detect that the engine and/or battery propulsion of the vehicle is turned off, the image capturing device immediately captures a second item of image information describing the environment of the vehicle when it is turned off. It is also possible to use the last image from an image sequence as the second item of image information, with the image sequence being sequentially captured by the image capturing device during the automated or autonomous travel to detect obstacles and/or for VPR-based geolocation (VPR: Visual Place Recognition).

By comparing the first item of image information and second item of image information to each other, it can be determined whether the position of the vehicle has been changed after its drive was shut down. In other words, it is determined whether the vehicle was moved by a transportation device while it was parked. This is critical to the nature and function of starting the GNSS receiver for the next ride.

There are many approaches to comparing two images by, e.g., comparing pixels and/or key features of the two images based on the Structural Similarity Index (SSIM Index) and/or mean square deviation. The key features can be objects such as landmarks and long-term buildings. Objects such as trees, pedestrians, and other vehicles cannot be considered when comparing. If the two images differ from each other, this may mean that the two images do not represent the same location.

To facilitate a comparison, the image capturing device can be preferably set at a same viewing angle when acquiring the first item of image information and the second item of image information, and the first and second items of image information can be captured in a same image format and file size, as well as at the same resolution. At least the camera-related factors able to can cause additional deviations between two images can thereby be kept to a minimum.

According to step c), the GNSS receiver is started while taking the comparison result in step b) into account.

The GNSS receiver can thereby be started according to the comparison result of the two items of image information items in three different ways, i.e., using a hot, warm, or cold start.

In a hot start, the previously tracked navigation satellites are still within view of the GNSS receiver and can be further tracked. In this context, the almanac and ephemeris data of the navigation satellites need not be updated if the almanac and ephemeris data are still valid. Therefore, it only takes a few seconds for position determination to become available. One of the prerequisites for a hot start is that the GNSS receiver has performed a positioning determination within the last hours (e.g., two to six hours with GPS) at approximately the same location. This requirement can be validated after the comparison result of the two items of image information is obtained.

If the GNSS receiver is still in the same location after the last position determination, but is turned off for too long, the ephemeris data can be out of date, although the last particular position is known and the almanac data is present. In this case, the GNSS receiver can be warm-started, only requiring an update of the ephemeris data. During a warm start, it can take approximately 45 seconds before a position determination is possible. One of the prerequisites for the warm start is that the GNSS receiver is at approximately the same location where it determined the last position when it starts up again. This requirement can be validated after the comparison result of the two items of image information are obtained.

If, based on the comparison result, the GNSS receiver is determined to be in a different location from where the GNSS receiver determined the last position at startup, the GNSS receiver can be cold-started. It can take several minutes to re-receive the almanac and ephemeris data.

With the described method, the image capturing device already established in the vehicle and the GNSS(/INS) geolocation system can be linked together to create an additional validation mechanism for utilizing the last determined and saved position when starting the GNSS receiver. To this end, at least the location prior to the start of the GNSS receiver is checked to determine whether the current location is the same location as when the vehicle was parked.

The method described is particularly suitable for automated or autonomous driving in the context of safety-critical automated or autonomous driving functions. It is particularly advantageous if an automated or autonomously driven vehicle which has particularly high requirements for safety and integrity (or accuracy of the location information, e.g. accuracy of the accuracy indication) is provided with an image capturing device and a GNSS receiver for performing the described method.

It is preferable, in step b), for the first and second items of image information to be compared to each other by the following sub-steps:
1) detecting a first location based on the first item of image information,
2) detecting a second location based on the second item of image information,
3) comparing the first and second locations to each other to determine whether the first and second items of image information describe the same location.

Instead of comparing the first and second items of image information immediately, the associated locations from the first and second items of image information can be first detected according to sub-steps 1) and 2), and then it can be determined according to sub-step 3) whether the two items of image information are describing the same location.

Using this indirect comparison and based on location detection, the additional deviation can be better tolerated, so a better comparison result can be provided. For example, the additional deviation can be caused by camera-related factors such as angle of view and/or exposure time and/or by natural influences such as different weather conditions, changes in lighting, etc.

It is possible to perform geolocation using pre-existing, publicly available georeferenced images such as those obtained from Google Street View or OpenStreetMap. In this context, researching georeferenced images in a publicly accessible source such as Google Street View can be done to find out which georeferenced image comprises the same key features as in the first or second items of image information. The geographic coordinates of that found image therefore correspond to the geographic coordinates of the first and/or second items of image information. The corresponding location can be detected according to the geographic coordinates.

It is preferable for the first and second locations to be detected using a convolutional neural network.

A convolutional neural network (CNN) is an artificial neural network, and is based on machine learning. It has a particularly good robustness in the extraction of key features from images compared to conventional methods such as SIFT (scale-invariant feature transform) or BoW (bag-of-visual-words).

Using a convolutional neural network, the comparison result of two images can be much less significantly influenced by the additional deviation caused by camera-related factors such as angle of view and/or exposure time and/or by natural influences such as different weather conditions, changes in lighting, etc. A better comparison result can therefore be provided using the convolutional neural network.

It is preferable, in step c), for the GNSS receiver to be cold-started when the first and second items of image information do not describe the same location. This can mean that the vehicle was transported from one location to another, such that the first and second items of image information are longer describing the same location. In this case, it is too risky to perform a hot or warm start of the GNSS receiver. It is therefore preferable to perform the cold start and receive a refreshed version of the complete almanac and ephemeris data.

It is preferable for the GNSS receiver to be hot-started or warm-started in step c) when the first and second items of image information are describing the same location. This can mean that the vehicle has not been transported from one location to another after parking, so that the first and second items of image information are describing the same location. In this case, the GNSS receiver can be hot-started without receiving refreshed almanac and ephemeris data, or warm-started only upon receiving refreshed ephemeris data if the vehicle has been parked for too long, the ephemeris data thus being out of date.

It is preferable for the second item of image information captured during shutdown of the vehicle to have been stored in a memory, and be read from the memory for comparison with the first item of image information captured during restart of the vehicle. This can mean that the second item of image information has been stored in a non-volatile data memory. It is also possible to store the last determined position information together with the second item of image information in the non-volatile data memory. For example, the position information can comprise the almanac and ephemeris data of the previously tracked navigation satellites for determining the last position. The location information can also generally include the geographic coordinates from the last georeferenced image if the image capturing device has previously made a Visual Place Recognition (VPR)-based geolocation. These geographic coordinates are useful in comparing the first and second items of image information for location detection based on the second item of image information.

It is preferable for the image capturing device to be a high-resolution camera. Such a camera is very often used in the field of autonomous driving or logistics to perceive the environment due to its price, size and weight advantage, and is well capable of linking to GNSS-based geolocation.

It is preferable for a GNSS receiver control unit to be configured to perform the described method.

It is also preferable for a computer program comprising commands to be used to perform a method described herein. In other words, this aspect relatives in particular to a computer program (product) comprising commands that, when the program is executed by a computer, prompt the latter to perform a method described herein.

Also preferred is the use of a machine-readable storage medium, on which the computer program proposed herein is stored. Conventionally, the machine-readable storage medium is a computer-readable disk.

It is particularly preferable that the geolocation system for a vehicle be configured to perform a method described herein.

In this context, the term “geolocation system” refers to a GNSS-based geolocation system comprising a GNSS receiver used for capturing GNSS data. The location and/or the time can be determined by way of the GNSS data. It is also possible for such a geolocation system to be a GNSS, INS, and VPR based geolocation system comprising a GNSS receiver, a camera, and a controller having a computer program and a machine readable storage medium used for performing the method described.

### BRIEF DESCRIPTION OF THE DRAWING

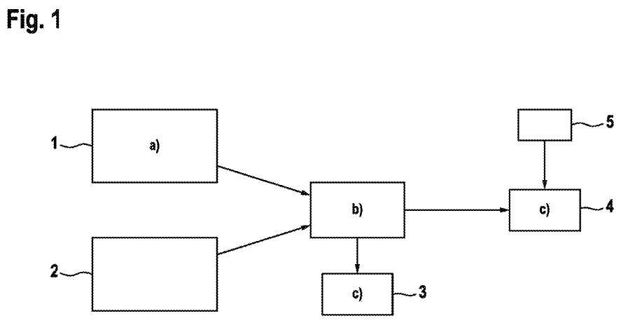

The disclosure and the technical environment are explained in further detail hereinafter with reference to FIG. 1. It should be noted that FIG. 1 is schematic in nature. It should also be noted that the features shown in FIG. 1 do not necessarily have to be used in the presented combination; partial features can rather be extracted and combined with other explanations in the description. Anything different is intended to apply only when explicitly referred to herein as a mandatory combination of features.

### DETAILED DESCRIPTION

FIG. 1 provides a schematic and exemplary illustration of a block diagram of the described method for starting a GNSS receiver installed in a vehicle. The first item of image information 1 and the second item of image information 2 previously captured in step a) are in this case read from a non-volatile memory in step b) and compared to one another in order to determine whether the two items of image information 1, 2 deviate from one another. The first item of image information 1 is captured by way of an image capturing device when the vehicle is started, and the second item of image information 2 has been previously captured by the image capturing device when the vehicle was parked. If, in step b), it is determined that the two items of image information 1, 2 deviate from one another, this can mean that the vehicle has been moved from one location to another location after parking and during parking. In this case, it is highly risky to hot-start the GNSS receiver in step c). Therefore, a cold start 3 is performed in step c). If it is determined in step b) that the two items of image information 1, 2 do not deviate from one another or the deviation is within a predefined tolerance range, this can mean that the vehicle is in the same location when it is parked and at start-up. In this case, a hot or warm start 4 is carried out in step c), whereby the previously saved position information 5 for the hot or warm start 4 is to be entered in step c).

Using the described method, the image capturing device already established in the vehicle can be linked to the GNSS(/INS) geolocation system, thereby realizing an additional validation mechanism for utilizing the last determined and stored position when the GNSS receiver is started.

The method described is particularly suitable for automated or autonomous driving in the context of safety-critical automated or autonomous driving functions.

What is claimed is:

1. A method for starting a GNSS receiver arranged in a vehicle, comprising:
(a) capturing, by way of an image capturing device, a first item of image information when the vehicle is started, wherein the first item of image information describes the environment of the vehicle when the vehicle is started;
(b) comparing the first item of image information captured in step (a) with a second item of image information captured by the image capturing device when the vehicle is parked and describing the environment of the vehicle when the vehicle is parked in order to determine whether the first item of image information and the second item of image information deviate from each other; and
(c) starting the GNSS receiver while taking the comparison result in step (b) into account.

2. The method according to claim 1, wherein, in step (b), the first item of image information and the second item of image information are compared to each other by way of the following sub-steps:
(1) detecting a first location based on the first item of image information;
(2) detecting a second location based on the second item of image information; and
(3) comparing the first and second locations to each other in order to determine whether the first item of image information and the second item of image information describe the same location.

3. The method according to claim 2, wherein the first and second locations are detected using a convolutional neural network.

4. The method according to claim 2, wherein, in step (c), the GNSS receiver is cold-started when the first item of image information and the second item of image information do not describe the same location.

5. The method according to claim 2, wherein, in step (c), the GNSS receiver is hot-started or warm-started when the first item of image information and the second item of image information describe the same location.

6. The method according to claim 1, wherein the second item of image information captured when the vehicle is parked has been stored in the memory, and is read from the memory to be compared to the first item of image information captured when the vehicle is restarted.

7. The method according to claim 1, wherein the image capturing device is a high-resolution camera.

8. A control device comprising at least one processor configured to perform a method according to claim 1.

9. A computer program product comprising commands that, when the computer program product is executed by a computer, prompt the latter to perform the method according to claim 1.

10. A computer-readable storage medium comprising commands that, when executed by a computer, prompt the latter to perform the method according to claim 1.

11. A geolocation system for a vehicle configured to perform a method according to claim 1.
